(19) United States
(12) Patent Application Publication
(10) Pub. No.: US 2024/0025740 A1
(43) Pub. Date: Jan. 25, 2024

(54) DEVICE, SYSTEM, AND/OR METHOD OF AN OZONE GENERATION MODULE

(71) Applicant: Roving Blue, Inc., Lena, WI (US)

(72) Inventor: Marianna DeMyer, Lena, WI (US)

(21) Appl. No.: 18/225,116

(22) Filed: Jul. 22, 2023

Related U.S. Application Data
(60) Provisional application No. 63/391,441, filed on Jul. 22, 2022.

(51) Int. Cl. C01B 13/10; C25B 1/13

(52) U.S. Cl. CPC C01B 13/10; C25B 1/13

(57) ABSTRACT

Disclosed is a to a method, a device, and/or a system of an ozone generation module. In one embodiment, an ozone generation module includes a housing having an interior and an exterior and an intake interface set in the housing for conveying a water into the interior of the housing. An electrode is exposed to the interior the housing, the electrode including an anode and a cathode that generates at least one of dissolved ozone and gaseous ozone in the water when a current is applied across the anode and cathode to result in an ozonated water. Also included are power leads including a first power lead coupled to the anode and transiting to the exterior of the housing and a second power lead coupled to the cathode and transiting to the exterior of the housing, and an output interface for outputting the ozonated water from the housing.

### CLAIM FOR PRIORITY

This patent application claims priority from, and hereby incorporates by reference: U.S. provisional patent application No. 63/391,441, entitled ‘DEVICE, SYSTEM, AND/OR METHOD OF AN OZONE GENERATION MODULE’, filed Jul. 22, 2022.

### FIELD OF TECHNOLOGY

This disclosure relates generally to water treatment and, more particularly, to a method, a device, and/or a system of an ozone generation module.

### BACKGROUND

Ozone is a powerful oxidant with many applications across many industries. For example, ozone is utilized as an antiseptic, disinfectant, water treatment, cleaning agent, commercial bleaching agent, and chemical reagent. Advantages of ozone for water treatment may include its strong oxidizing capability, relatively short lifespan, its inability to turn into halogenated carbon compounds, and similarly its decomposition into non-toxic diatomic oxygen gas. Ozonated water can also be used for many purposes such as wound disinfection (e.g., to treat an injury or for a mobile hospital) and as a general cleaning agent.

However, use of ozone can also pose challenges. For example, ozone may not be inherently soluble in water, and may tend to form as small gas bubbles where the ozone may escape the water being treated, decreasing the dissolved ozone concentration and therefore treatment effectiveness.

One method for generation of ozone is electrolytic ozone production utilizing an electrode. While electrolytic ozone generation may have some advantages, it may also have some disadvantages. For example, it can be difficult to determine if sufficient ozone concentration has built up in treated water. As another example, electrodes may tend to eventually decrease in efficiency, burn out, or otherwise need replacement. In addition, electrodes and water bearing components may be designed for each application for use. It may also be difficult to install, program, adapt, and/or replace ozone components in equipment and/or appliances. For example, ozonation equipment and/or electrodes may have been permanently integrated into the equipment and/or appliance.

Water treatment devices, systems, and methods are important technology without which people may not have access to safe or effective water. While ozone provides an advantageous approach to water treatment, new and improved methods of water treatment, maintenance, and the integration into equipment and/or appliances are desirable to further improve ozone's reliability, usability, and effectiveness.

### SUMMARY

Disclosed are a method, a device, and/or system of an ozone generation module. In one embodiment, an ozone generation module for generating ozonating water includes a housing, an intake interface, an electrode, power leads, and an output interface. The housing has an interior of the housing and an exterior of the housing. The intake interface is set in the housing and utilized for conveying a water into the interior of the housing. The electrode is exposed to the interior the housing. The electrode includes an anode and a cathode that generates dissolved ozone and/or gaseous ozone in the water when a current is applied across the anode and cathode to result in an ozonated water. The power leads include a first power lead coupled to the anode and transiting to the exterior of the housing and a second power lead coupled to the cathode and transiting to the exterior of the housing. The output interface is utilized for outputting the ozonated water from the housing.

The ozone generation module may include a baffle impeding a flow of the water from the intake interface to the output interface to increase contact time of the water with at least one of the electrode and the dissolved ozone. The baffle may be a convolutional baffle directing water in a spiral as the water moves through the interior of the housing. The convolutional baffle may surround the electrode such that at least a portion of the water moves circularly around the electrode as the water moves from the intake interface to the output interface.

The ozone generation module may further include a flow detector configured to detect a flow of the water and/or a flow rate of the water moving through the ozone module and/or a sensor line coupled to the flow detector and transiting the housing for communicating a flow signal.

The ozone generation module may further include a controller communicatively coupled to the power leads. The controller may include a processor and a memory. The memory may include a configuration data and an ozone initiation routine. The configuration data includes at a voltage value and/or an amperage value, and the ozone initiation routine includes computer readable instructions that when executed: receive an execution command, determine at least one of the flow is occurring and the flow rate exceeds a threshold value, and supply power to the power leads according to at least one of the voltage value and the amperage value.

The ozone generation module also may include a user interface communicatively coupled to the controller for generating the execution command. The user interface may include a light interface. The memory may further include an ozone indication routine that includes computer readable instructions that when executed: (i) initiate a first color on the light interface indicating that an ozone concentration in the water is insufficient, (ii) determine the flow has exceeded a threshold time and/or the flow rate of the water has exceeded a threshold volume specified in the appliance configuration data, and (iii) initiate a second color on the light interface indicating that the ozone concentration in the water is sufficient.

The ozone module of claim 2, wherein the baffle impeding the flow of the water comprises a first barrier between the anode and the cathode, a second barrier between the anode and the interior of the housing, and a third barrier between the cathode and the interior of the housing.

The intake interface and/or the output interface may include a quick connect coupler. The anode of the electrode may include boron doped diamond and/or tin-nickel oxide. The cathode of the electrode may include stainless steel. The anode and cathode may be electrically coupled with a proton exchange membrane (PEM) such that the water flows around the electrode without passing through a gap between the anode and cathode. A travel distance of the water from the intake interface to the output interface may be greater than or equal to a longest dimension of the exterior of the housing.

The ozone generation module may further include a power supply electrically coupled to the electrode and/or a total dissolved solid (TDS) sensor for detecting a TDS value of the water. The memory may further include a TDS regulation routine comprising computer readable instructions that when executed: detect the TDS value of the water, determine a second voltage value to supply to the electrode at the TDS value, and supply power to the electrode at the second voltage value and at a current value that is constant. The power supply may include a constant voltage power supply and optionally a constant current power supply.

The memory may further include a module coordination routine that includes computer readable instructions that when executed: determine an error status of the ozone module, and initiate ozone generation of a second ozone module serially configured with the ozone module along a flow channel of the water. The memory may also further include an electrode monitoring routine that includes computer readable instructions that when executed: detect an error status resulting from an electrical property of the electrode, and activate an indicator element of a user interface and/or stop power flowing from the power supply to the electrode. The electrical property is a resistance change in the electrode.

### BRIEF DESCRIPTION OF THE DRAWINGS

The embodiments of this disclosure are illustrated by way of example and not limitation in the figures of the accompanying drawings, in which like references indicate similar elements and in which:

FIG. 1 illustrates an ozone generation module (also referred to herein as an “ozone module”) including an electrode for generating electrolytic ozone, according to one or more embodiments.

FIG. 2 illustrates a controller system, for example for the ozone generation module of FIG. 1, according to one or more embodiments.

FIG. 3 illustrates an appliance and/or equipment ozonation system in which the ozone generation module of FIG. 1 and/or the controller system of FIG. 2 may be integrated with and/or into an appliance and/or one or more pieces of equipment, according to one or more embodiments.

FIG. 4 illustrates a cut away view of a replicable ozone module including a set of baffles impeding the flow of the water, according to one or more embodiments.

FIG. 5A illustrates another cut away view of a replicable ozone module including convolutional baffles promoting circular flow of water to increase mixing and/or contact time of ozone generated by the electrode, according to one or more embodiments.

FIG. 5B illustrates a housing of a replicable ozone module including internal convolutional baffles, according to one or more embodiments.

Other features of the present embodiments will be apparent from the accompanying drawings and from the detailed description that follows.

### DETAILED DESCRIPTION

Disclosed are a method, a device, and/or system of an ozone generation module. Although the present embodiments have been described with reference to specific example embodiments, it will be evident that various modifications and changes may be made to these embodiments without departing from the broader spirit and scope of the various embodiments.

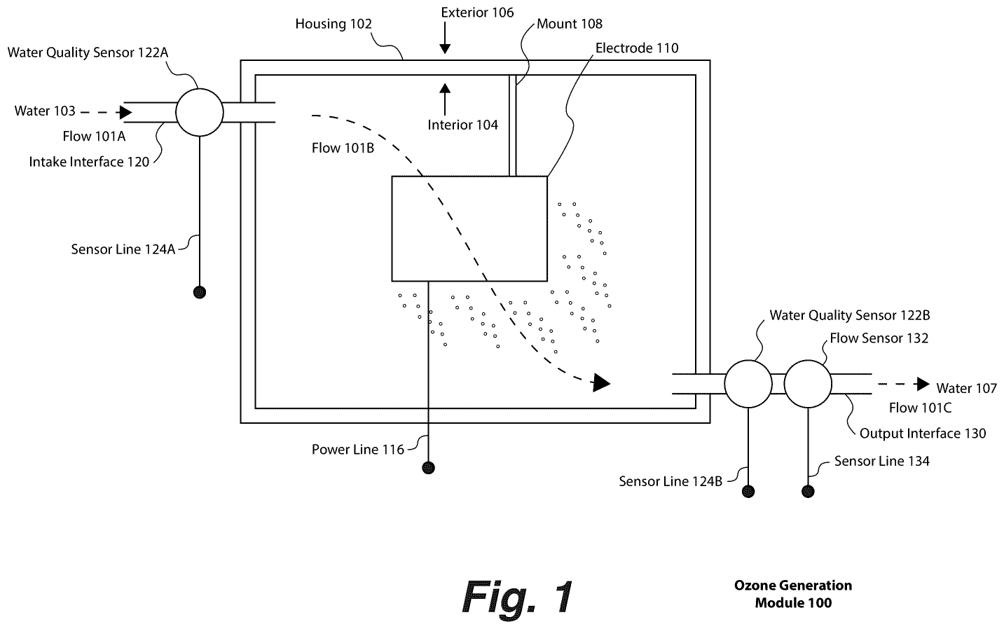

FIG. 1 illustrates an ozone generation module 100, according to one or more embodiments. The ozone generation module 100 (also referred to herein as the ozone module 100) may be a replaceable ozonation unit that can be installed for use with a water utilizing system such as a fluid line, a holding tank, a water-utilizing appliance, a water-utilizing equipment, and/or other water utilizing item. The ozone may be used for a wide variety of uses as known in the art, including household cleaning and sanitation, water treatment (for potability or use as drinking water), chemical reagents, antiseptic, and/or medical uses. The water utilizing system, for example, may be a household facet, a refrigerator, a washing machine, a shower head, a dishwasher, a commercial ice maker, a pressurized beverage dispensing system, soda fountain or beer tap lines, and/or other commercial and/or industrial systems utilizing water.

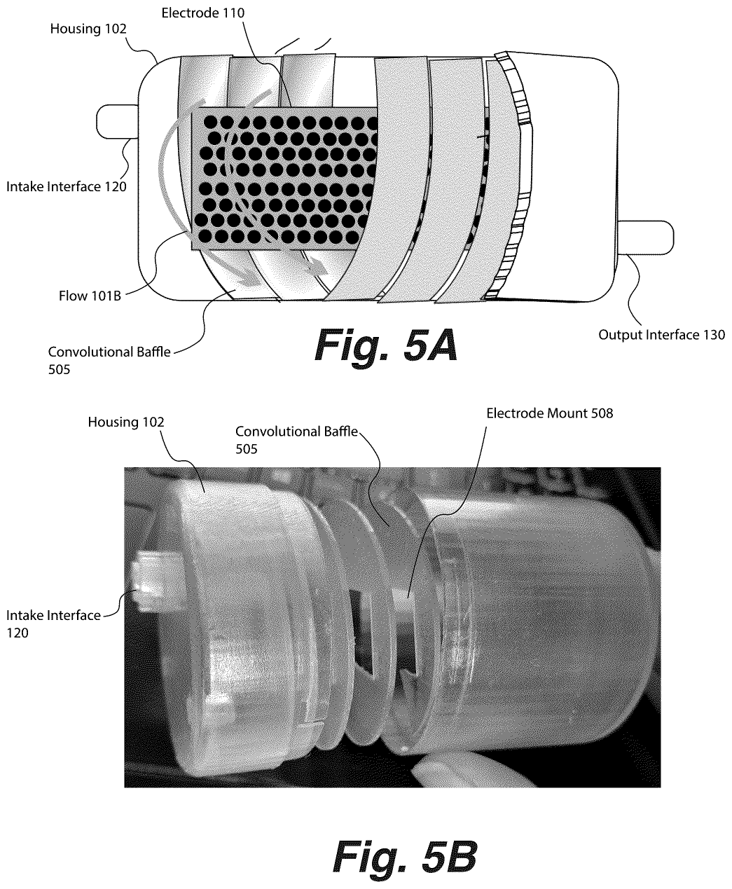

The ozone generation module 100 includes a housing 102 having an interior 104 and an exterior 106. The interior 104 may encapsulate an ozone generator such as the electrode 110. The interior 104 is watertight and/or water resistant. The housing 102 is therefore made of a suitable material and/or lined with a suitable material for water resistance and/or to form a waterproof barrier. In one or more embodiments, the housing may be made from plastic, for example two injection molded halves that may be bonded, glued, and/or otherwise fixed together with a water tight seam. Alternatively or in addition, the housing 102 could be a capsule with a lid and a seal (e.g., made from rubber) on one end, for example as shown and described in conjunction with the embodiment of FIG. 5B.

The electrode 110 may be fixed and/or mounted within the interior 104 such that it contacts untreated water (referred to herein as the water 103) when the water 103 enters the interior 104. In one or more embodiments, the mount 108 may be attached to the housing 102 and the electrode 110, for example suspending the electrode in the cavity and/or chamber of the interior 104.

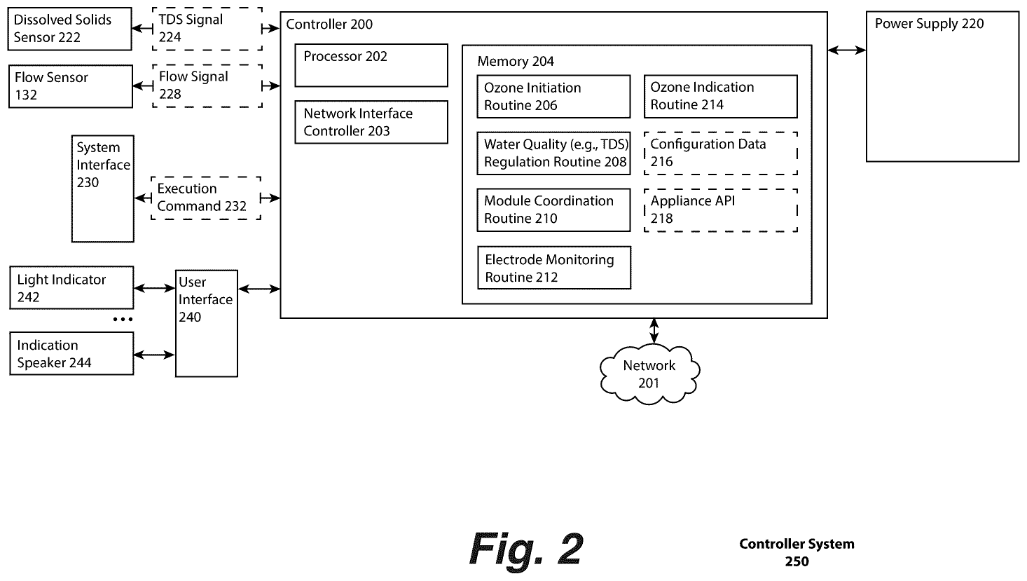

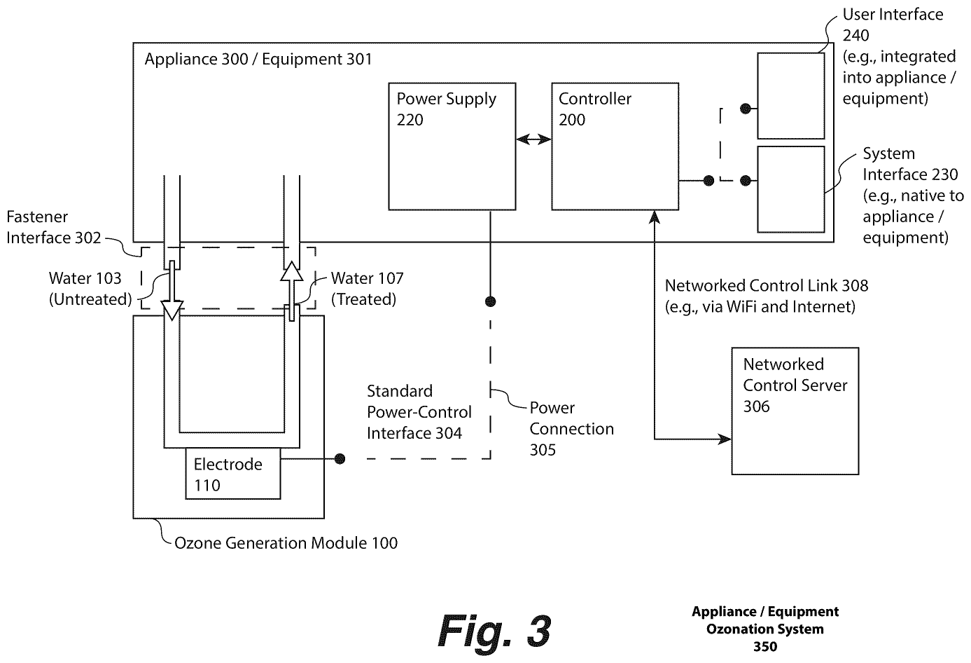

In one or more embodiments, the electrode 110 may comprise a tin-nickel anode, for example a tin-nickel antimony electrode on a titanium or other substrate as may be known in the art. See Wang, et al (J. Electrochem. Soc., Volume 152(11), pp D197-D200 (2005). In one or more embodiments, the cathode 114 may comprise stainless steel or another suitable conducting non-reactive material resistant to oxidation. In one or more embodiments, other electrodes may be utilized including electrodes based on platinum, lead oxide, and/or boron doped diamond. Ozone 105 may be produced at an anode of the electrode 110 (e.g., the anode 112) and hydrogen may be produced at a cathode of the electrode 1110 (e.g., the cathode 114). Additional components may include a power line 116 that may comprise two leads (e.g., a power lead 117A and a power lead 117B, as shown in FIG. 3) connecting each of the anode 112 and the cathode 114 to a power source (e.g., a power supply 220 of FIG. 2).

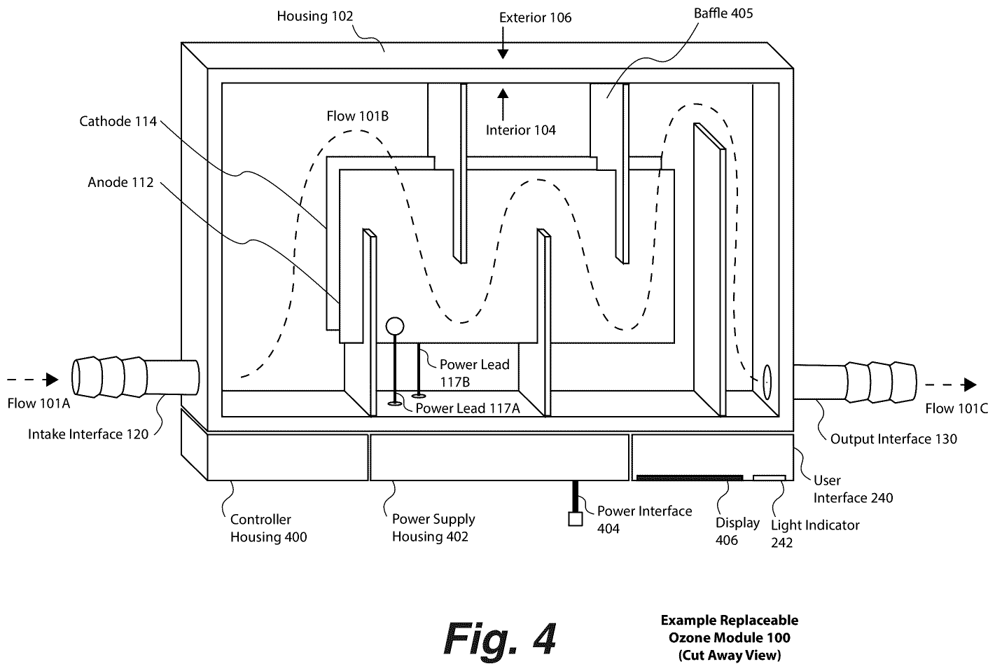

The water 103 that may be untreated and may flow into the housing 102 by way of an intake interface 120. The water 103 may be drawn from many sources, such as a municipal water supply, a local water tank (e.g., on a truck or other mobile unit), directly from untreated water (e.g., a lake, a well, a river), and/or other sources. In certain applications, other aqueous solutions may be pumped through, for example soiled water, sewage, or highly contaminated water requiring oxidation for treatment. The intake interface 120 may include one or more interfacing elements and/or adapters, for example screw threads, quick connect couplers, and/or friction fitting elements for tubing (e.g., as shown and described in conjunction with FIG. 4). In one or more embodiments, the intake interface 120 may be configured for fast (and optionally toolless) connection and disconnection of the ozone generation module 100, enabling easy, efficient, and/or rapid replacement if needed. Similarly, the output interface 130 may include one or more interfacing elements and/or adapters, for example screw threads, quick-disconnect fasteners, and/or friction fitting elements for tubing. The output interface 130 outputs treated and/or ozonated water (referred to herein as the water 107).

In one or more embodiments, water 103 moves into the ozone generation module 100 by way of the flow 101A, which may be an ambient pressure of the water 103 (e.g., a household kitchen faucet pressure, pressure provided by a pump, pressure provided by gravity feed, etc.). The water 103 may then enter the chamber of the interior 104, filling the chamber of the interior 104 and/or covering the surface of the electrode 110. Although the entirety of the interior 104 may be filled, in general the water 103 will flow along the flow 103B from the intake interface 120 to the output interface 130.

The electrode 110 may be activated, as further shown and described in conjunction with the embodiment of FIG. 2. Activation may generally occur by simply providing power to the electrode 110, e.g., a voltage difference across the anode 112 and the cathode 114 utilizing the water 103 to complete a circuit. Power may be supplied via the power line 116, which may transit a wall of the housing 102 through a rubber seal, gasket, or other method of waterproof transiting to the exterior 106 of the housing 102.

The flow 101B may proceed through the interior 104 to the output interface 130, receiving an infusion of the ozone 105 generated by the electrode 110. As further shown and described herein, additional strategies may be utilized to prolong a contact time of the ozone 105 with the water 103 in the interior 104, for examples barriers and/or baffles that create a prolonged and/or convoluted path for the flow 101B (e.g., as shown in FIG. 4).

In one or more embodiments, one or more sensors, and data and/or signals generated therefrom, may be utilized in the control of the ozone generation module 100. In one or more embodiments, the intake interface 120 and/or the output interface 130 may include a water quality sensor 122 (e.g., the water quality sensor 122A and the water quality sensor 122B, respectively). Water quality may be broadly defined, for example a total dissolved solid level, a water hardness (e.g., CaCO3 levels), detection of a contaminant (e.g., arsenic, pesticides). A sensor line 124 may be used to communicate a signal carries information about the water quality to the controller 200 (e.g., a sensor line 124A for the water quality sensor 122A). The water quality sensor 122B, if placed in conjunction with the output interface 130 for the water 107, may also include an oxidation reduction potential (ORP) probe that may determine a strength and/or a concentration of the ozone 105 in the water 107.

In one or more embodiments, the ozone generation module 100 may include and/or the controller 200 for the ozone generation module 100 may receive a signal and/or data from a flow sensor 132. The flow sensor 132 may determine that the flow of water is occurring, may determine the flow of water is above a threshold rate, and/or may determined a flow rate of the water (e.g., either the flow 101A, the flow 101B, and/or the flow 101C, depending on where the flow sensor 132 is placed). In the present embodiment, the flow sensor 132 is shown placed in conjunction with the output interface 130. However, in one or more embodiments, the flow sensor 132 may not be part of the replaceable portion of the ozone generation module such that it is reusable even where the housing 102 bearing the electrode 110 is replaceable and/or replaced (this may be also the case with one or more water quality sensors 122). The flow sensor 132, for example, may be utilized to help determine: (i) when to indicate to a user that the water 107 is safe to utilize, (ii) when it is safe to run the electrode 110 (e.g., sufficient water 103 and flow 101B is present to allow for conductivity across the electrode and/or to prevent overheating or over-oxidation), and/or (iii) the parameters of operation of the ozone generation module 100 and/or the appliance or equipment to which it may be coupled. The water 107, having been ozonated, may then be utilized for an application (e.g., sanitation, drinking, as a reagent), or may be post-processed or stored for later use.

In one or more embodiments, an advantage of the ozone generation module 100 is: (i) allowing for easy replacement of a single unit with standard connection interfaces (e.g., electrical failure, cracking of the housing, failure of waterproof components, burnout of the electrode 110); (ii) a separation of a replicable component having the electrode 110 while a separate controller 200 and/or controller system 250 is reusable throughout the lifespan of many ozone generation modules; (iii) a stand alone unit that can be combined in various configurations (e.g., in series, in parallel), to meet the demands of specific needs (e.g., backup and redundancy, flexible ozone generation output to meet variable flowrates, etc.); and/or (iv) containing ozone generation and utilizing electrolytic ozone to reduce the amount of excess gaseous ozone that can cause skin or lung irritation or otherwise act as an environmental contaminant. Other advantages will be apparent to one skilled in the art.

FIG. 2 illustrates a controller system 250, according to one or more embodiments. The controller system 250 may be utilized to control the ozone generation module 100. One or more elements of the controller system 250, including the controller 200, may be physically mounted and/or included within the ozone module 100, and/or may be power-coupled and communication-coupled (but not necessarily physically associated with) the ozone module 100. The controller system 250 may comprise a controller 200, a power supply 220, one or more sensors (e.g., the water quality sensor 122, the flow sensor 132), and/or one or more interfaces (e.g., a system interface 230 that may be integrated with an appliance 300 and/or piece of equipment 301, a user interface 240 that may focused on use and operation of the ozone generation module 110).

The controller 200 may include a processor 202 (e.g., a computer processor, a microcontroller), a memory 204, and optionally a network interface controller 203 that may allow for connectivity of the controller 200 and/or network control, for example as further shown and described in conjunction with FIG. 3. The network interface controller 203 may allow for communication over one or more standardized digital protocols, including for example Bluetooth®, radio wave protocols, wired protocols (e.g., TWI), ethernet, etc. The power supply 220 may be a DC to DC converter and/or an AC to DC converter, and may include a constant voltage power supply and/or optionally a constant current power supply.

The memory 204 may be a computer memory storing one or more sets of data and/or executable instructions. In one or more embodiments, the memory 204 may store an ozone initiation routine 206 comprising computer readable instructions that when executed receive an execution command (e.g., the execution command 232), determine the flow (e.g., the flow 103A, the flow 103B, and/or the flow 103C) is occurring and/or determine the flow rate exceeds a threshold value, and supply power to the power leads (e.g., the power line 116) according to at least one of the voltage value and/or the amperage value. The memory may also store a water quality regulation routine comprising computer readable instructions that when executed detect the quality value of the water (e.g., the water 103, the water 107), determine a second voltage value to supply to the electrode at the quality value, and supply power to the electrode 110 at the second voltage value (that may subsequently be allowed and/or controlled to vary over time) and at a current value that is constant. Alternatively, or in addition, the water quality regulation routine 208 may be a TDS (total dissolved solids) regulation routine 209 (not shown), where the water quality level is a TDS level.

The memory 204 may include a module coordination routine 210. In one or more embodiments, the module coordination routine 210 may include computer readable instructions that when executed: (i) determine an error status of the ozone module 100 (e.g., that may be a first ozone module 100A), and/or (ii) initiate ozone generation of a second ozone module 100 (e.g., that may be the second ozone module 100B) serially configured with the ozone module 100A along a flow channel of the water (e.g., a linear line, a serial water supply).

The memory 204 may further include an electrode monitoring routine 212. The electronic monitoring routine 212 may include computer readable instructions that when executed: (i) detect an error status resulting from an electrical property of the electrode 110, and (ii) activate an indication element of a user interface 240 and/or the system interface 230. The activated indication element, for example, may be to issue a notice on a display (e.g., the display 406 of FIG. 4, a display of the appliance 300), activate a light indicator 242, and/or sound an audible alarm on the indication speaker 244, according to one or more embodiments. Alternatively, or in addition, the electronic monitoring routine 212 may include computer readable instructions that when executed stops power flowing from the power supply 220 to the electrode 110. In one or more embodiments, the electrical property may be a resistance change in the electrode as may be measured through one or more sensors (not shown) or electrical properties of electricity supplied on the power line 116.

In one or more embodiments, the memory 204 may include an ozone indication routine 214. In one or more embodiments, the ozone indication routine 214 may include computer readable instructions that when executed: (i) initiate a first color (e.g., red) on a light interface (e.g., the light indicator 242, and/or a display screen) indicating that an ozone concentration in the water 107 is insufficient (e.g., as may be determined by sensor measurements, and/or a calibration process described below); (ii) determine the flow (e.g., the flow 101A, the flow 101B, and/or the flow 101C) has exceeded a threshold time and/or the flow rate of the water (e.g., the water 103, the water 107) has exceeded a threshold volume (e.g., a volume specified in the configuration data 216), and/or (iii) initiate a second color (e.g., blue) on the light interface indicating that the ozone concentration in the water is sufficient (e.g., as may be determined by sensor measurements, and/or a calibration process described below).

In one or more embodiments, ozone sufficiency may be determined by sensors. For example, the oxidation reduction potential of the water 107 may be sufficient when it rises (as sensed by a water quality sensor 122B that is an ORP sensor) to a certain threshold value, as may be hard-coded in the ozone indication routine 214 and/or read through the configuration data 216. In one or more other embodiments, the ozone sufficiency may be determined through a calibration process in which the ozone module 100 is installed in an intended environment (e.g., an appliance 300, an in-line water system), and tests are performed at given flow rates, flow volumes, and flow time lengths. For example, for kitchen faucet, it may be determined that 500 milliliters of water should pass through the ozone generation module 100, then a current flow rate of between 100 to 300 milliliters of water per second should be detected, before indicating that the water 107 is safe to utilize. This may be useful for certain application in which too little or too much ozone could pose a risk to damaging the surroundings or human health. In one or more embodiments, the configuration data 216 may include a voltage value and/or an amperage value of a voltage and a current, respectfully, to supply to the electrode 110 under certain circumstances. As discussed below, the power supply 220 may be able to supply a constant current or a constant voltage while varying the other, as may be known in the art, according to one or more embodiments.

The configuration data 216 may be stored data that may specify certain parameters of operation. In one or more embodiments, the configuration data 216 may allow for tuning of the controller system 250 to certain custom appliances or pieces of equipment and/or the ability to serve multiple product lines. For example, the configuration data 216 may contain the operation parameters for multiple types of refrigerators offered by a company (e.g., the manufacturer, an OEM manufacturer, a dealer selling and/or modifying equipment, etc.), where upon installation the company need only specify the make and/or the model of the appliance for correct operation. The configuration data 216 may also enable repair, adjustment, and/or fine-tuning of operation of the ozone generation module 100, for example due to varying water quality in the water 103 that is untreated at different times of the year or if the application of the water 107 is changed (e.g., consumption versus disinfection). In one or more embodiments, the configuration data 216 may be set, changed, and/or accessed through the system interface 230 and/or the user interface 240, or remotely through the network interface controller 203.

In one or more embodiments, the controller 200 may contain an appliance application programming interface, referred to as the appliance API 218. The appliance API 218 may include a programming interface that receives electronic instructions from a system interface 230 and/or an appliance 300 (and/or piece of equipment 301) and generates an instruction for the controller 200. For example, and as further described in conjunction with FIG. 3, the appliance 300 may include a system interface 230, for example a set of buttons and/or display screen set in the door of a refrigerator that a user may interact with to control the appliance 300. The user may select “ozonated water”, at which point the system interface 230 may generate the execution command 232 that may be transmitted to the controller 200 and received by the appliance API 218, where the execution command 232 may be translated into one or more executable instructions, for example for the ozone initiation routine 206. The execution command 232 may be in a standard format language, and/or protocol of the appliance supplier, whereas the appliance API 218 may be an interface with the formats of multiple appliance suppliers, in one or more embodiments. Alternatively, or in addition, the system interface 230 may generate the execution command 232 in a language native to the controller 200.

In one or more embodiments, the controller 200 may include and/or may be communicatively coupled with a user interface 240. The user interface 240 may include both control aspects (e.g., buttons, touchscreens), and indicators (e.g., the light indicator 242, the indication speaker 244). In one or more embodiments, the light indicator 242 may be integrated into the appliance, for example a ring of LED lights with a light dispersion plate around a rim of a kitchen faucet that may create a continuous soft ring of light that change colors as an indicator to the user (e.g., a color change as a result of execution of the ozone indication routine 214). As just one example, white light may indicate that the ozone module is powered and on standby, yellow light may indicate ozonation is beginning, blue light may indicate that the water 107 is ready for use, orange light that the ozone module 100 may soon need to be replaced based on performance or other metrics (e.g., resistance of the electrode 110), and/or red light may indicate a fault has occurred with the ozone module 100.

In one or more embodiments, the controller 200 may be coupled with a dissolved solids sensor 222, which may generate a TDS signal 224 that may communicate a TDS level above a certain threshold and/or an amount of total dissolved solids in the water 103 and/or the water 107. The dissolved solids sensor 222 may be an instance of the water quality sensor 122. A flow sensor 132 may also be communicatively coupled to the controller 200, according to one or more embodiments. The flow sensor 132 may generate a flow signal 228 which may indicate that the flow rate (e.g., the flow 101A, the flow 101B, the flow 101C) is above a threshold, and/or may transmit data that includes a value of the flow rate.

The power supply 220 may be a battery, a DC converter connected to AC current (e.g., a wall socket), an internal and/or dedicated power supply of an appliance and/or piece of equipment, and/or another power source. The power supply 220 may include either or both of a constant voltage power supply and a constant current power supply, either of which may be used to control the electrode 110 under either constant voltage while varying current, or constant current while varying voltage, respectively. This may be useful, for example, to adjust ozone output depending on water quality. As one example, where conductivity of the water 103 is lower, increased voltage may be utilized to increase ozone 105 production.

The controller 200 may be connected to a network 201 through the network interface controller 203, according to one or more embodiments. The network 201 may be a local area network, a wide area network, and/or the internet. The controller 200 may be controllable through the network 201.

FIG. 3 illustrates an appliance/equipment ozonation system 350, according to one or more embodiments. The equipment 301 could be, for example, an industrial chemical reagent generator, equipment requiring disinfection and/or oxidizing purges or flushes of disinfecting water, a piece of medical equipment requiring generation of antiseptic or sterile water, or other residential, commercial, medical, or industrial equipment. The appliance 300 could be a residential appliance and/or fixture, for example a kitchen faucet (e.g., that may have filters, powered elements (e.g., a powered reverse osmosis system), or other elements), a bathroom faucet, a show head, a washing machine, a water treatment system (e.g., for removal of minerals), a toilet, a drain system, a garbage disposal, a dishwasher, and/or other appliances. The appliance 300 may also be a similar commercial and/or industrial appliance (e.g., a commercial dishwasher).

In one or more embodiments and the embodiment of FIG. 3, the ozone generation module 100 may be replaceably coupled to the appliance 300 and/or equipment 301 through a fastener interface 302. For example, the fastener interface 302 may comprise quick-disconnect connectors, clamps, a set of friction-fitting tubing, and/or other pipe, tubing, and/or line couples able to be disconnected, as known in the art. The fastener interface 302 may comprise the intake interface 120 and/or the output interface 130. In one or more embodiments, the ozone generation module 100 may be physically coupled to the appliance 300 and/or equipment 301, for example through a bracket and/or mount. In one or more embodiments, it should be noted that the water 103 may be sourced from outside the appliance 300 and/or equipment 301. Similarly, the water 107 that is treated may be supplied directly from the ozone generation module 100, and/or to a different piece of equipment 301 and/or appliance 300.

The ozone generation module 100 may be powered by a power system and/or by power supplied of the appliance 300 and/or the equipment 301. In one or more embodiments, the power supply 220 may be specialized for use in powering the controller 200 and/or the electrode 100, but the power supply 220 may receive power from a different power supply (not shown) of the appliance 300 and/or the equipment 301 (which may be in turn connected to a standard 120V 60 Hz wall socket, a 3-phase 220 volt outlet, a battery, a solar array, etc.). In one or more other embodiments, a native power supply of the appliance 300 and/or the equipment 301 may be able to suitably supply power to the electrode 110 and/or the controller 200.

The ozone generation module 100 may be connected to the power supply 220 through a standard power-control interface 304, for example standard pinned connectors, to form the power connection 305. It should be noted that, in one or more embodiments, an advantage is the removal and replacement of the ozone generation module 100 (e.g., due to a depleted or damaged electrode 110) without changing the power supply 220 and/or the controller 200. However, it one or more other embodiments, the ozone generation module 100 that is replaceable may include a power supply 220, a controller 200, and/or a user interface 240 intended to be removed and replaced along with the ozone generation module 100.

The controller 200 may control the power supply 220 and/or the supply of power to the ozone generation module 100. The controller 200 may be integrated into a native controller of the equipment 300 and/or the appliance 301, and/or may be a separate instance of a controller along with any controllers or processors of the appliance 300 and/or the equipment 301. The controller 200 may be coupled to a system interface 230 that may be integrated into and/or native to the appliance 300 and/or the equipment 301. As just one example, where the appliance 300 is a chemistry lab glassware disinfection washing machine, the system interface 240 may be a set of buttons on the outside of the appliance 300 specifying start, stop, the intensity, duration, and/or other parameters of operation for the appliance 300. Certain selections on the system interface 240 (e.g., start) may cause the controller 200 to await flow sensing and then initiation power to the electrode 110, as previously described. In another example, certain selections on the system interface 240 (e.g., a higher intensity) may communicate signals and/or data to the controller 200 such that a higher voltage is provided to the electrode 110 during operation (as may be specified in the configuration data 216). As described above, the system interface 230 may communicate with the controller 200 through the appliance API 218.

The ozone generation module 100 may also have its own dedicated user interface 240, that may or may not be integrated with the appliance 300 and/or the equipment 301. For example, where the appliance 300 is a kitchen faucet, the user interface 240 may be one or more LEDs (e.g., a light ring around the dispensing portion of the faucet) that may change colors depending on operation of the ozone generation module 100. Another example of the user interface 240 may be a display, buttons, and/or indicator lights in or connected with a housing 102 that may be attachable to the appliance and/or equipment, for example for “retrofitting” the appliance 300 and/or equipment 301, and which could be placed proximate to the system interface 230.

In one or more embodiments, the ozone module 100 may be utilized in the medical industry and/or in conjunction with appliances and equipment used therein, for example for use with sanitizing stations for hands or equipment (e.g., an example of the equipment 301, such as a hand sanitizing spray which detects the presence of a hand), human ozone therapy equipment, veterinary medicine equipment, and/or animal ozone therapy. In one or more embodiments, the ozone module 100 may be utilized in agriculture and/or in conjunction with appliances and equipment used therein, for example hydronics (e.g., cleaning systems and water lines, etc.), dairies (e.g., livestock udder cleaning, automatic milking equipment cleaning, etc.), aquaponics (e.g., preventing algal blooms or bacteria colonies, etc.), meat processing (e.g., meat disinfection, equipment disinfection) and/or greenhouse or indoor vertical farming. In one or more embodiments, the ozone module 100 may be used in dentistry and/or in conjunction with appliances and equipment used therein, for example oral surgery irrigation, gum disease treatments, and tool and equipment disinfection. In one or more embodiments, the ozone module 100 may be used in dentistry and/or in conjunction with water reuse and collections systems, and appliances and equipment used therein, for example rooftop rainwater collection, greywater system treatment and water collection, septic systems, etc. In one or more embodiments, the ozone module 100 may be used for residential purposes and/or in conjunction with appliances and equipment used therein, for example: a fruit and/or vegetable washing station, self-cleaning toilets and urinals, and/or pet watering stations. Similarly, in one or more embodiments the ozone module 100 may be used in air processing units to remove smell or molecular contaminants from a room, de-humidifiers that do not build-up remove mold and mildew, floor moppers with automatically dispensed ozone cleaning agent (e.g., the water 107) from ordinary tap water (e.g., the water 103), and washing machines that can select the utilization of ozone instead of, or in addition to, detergent (e.g., an “ozone” cycle). In one or more embodiments, the ozone module 100 may be used in consumer products holding or dispensing water, for example a pitcher, a water bottle, or a 5-gallon water tank.

The controller 200 may be communicatively coupled with a control server 306 over a network control link 308, for example a WiFi® connection, a local are network, a wide area network, and/or the internet. The control server 306 may be able to communicate with, remotely control and/or remotely monitor the controller 200. For example, the control server 306 may receive alerts when a fault or error occurs with the electrode 110 such that an alternative or redundant system can be activated, and/or repair personnel notified and dispatched.

FIG. 4 illustrates an example of the ozone generation module 100, according to one or more embodiments. The electrode 110 is illustrated comprising two plates, the anode 112 and the cathode 114, spaced such as to be electrically coupled through the water in the interior 104 of the housing 102. The anode 112 and the cathode 114, in one or more embodiments, may be suspended in the interior 114, held in place by one or more baffles 405. Similarly, the anode 112 and the cathode 114, in one or more embodiments, may be properly spaced for electrical coupling through the water 103 by the one or more baffles 405. In one or more embodiments, one or more baffles 405 may channel a flow of water through the interior 104, as illustrated by the flow 104B of FIG. 4, such that contact time with the electrode 110 and the ozone 106 produced therefrom is increased, which may increase ozone concentration and dissolution in the water 107. In one or more embodiments, the baffle 405 may impede the flow (e.g., 101B) of the water from the intake interface 120 to the output interface 130 to increase contact time of the water with at least one of the electrode 110 and the dissolved ozone 105.

The baffles 405 may be made of the same material as the housing 102, or a different suitable material that will not oxidize or break down within the designed lifespan of the electrode 110. The lifespan of the electrode 110 may be dictated by the care in which ozone generating catalytic coatings are applied to the substrate, the catalytic material selected, the quality of electrical components, etc., which may be selected for the particular economic requirements for a given application or industry. The baffles 405 may be comb-like, with at least two slits in the portion protruding into the interior 104 so as to receive the plates of each of the anode 112 and the cathode 114. In one or more embodiments, the housing 102 may be molded or additively manufactured in two halves, including the baffles 405, allowing the electrode 110 to be slid between and/or suspended within the baffles 405 and the housing 102 then fit together around the electrode 110.

In the embodiment of FIG. 4, and one or more other embodiments, the ozone module 100 may include a controller housing 400, a power supply housing 402, a power interface 404, and a housing for the user interface 240, including a display 406 and a light indicator 242. In such example, the ozone module 100 may be replaced in its entirety with these components (and/or some may be reusable). In the present example, the slender rectangular profile may accommodate appliances 300, equipment 301, and/or other applications where the ozone module 100 must be able to fit into a tight or measured space. Similarly, it may be easy to specify and designed-around the thin profile for equipment assembly.

In one or more embodiments, the baffle 405 impeding the flow of the water may include a first barrier between the anode 112 and the cathode 114, a second barrier between the anode 112 and the interior 104 of the housing 102, and a third barrier between the cathode 114 and the interior 104 of the housing 102. Each instance of the barrier 405 in FIG. 4 achieves the first barrier, the second barrier, and the third barrier through its comb-like structure (it should be noted that the housing 102 is seen with a closest side transparent and/or removed for clarity.

Although a rectangular plate is shown for the electrode 110 in FIG. 4, in one or more embodiments, electrodes 110 of many shapes or sizes may be selected, for example rods. Other electrodes 110 may include 3D printed and/or additively manufactured electrodes designed to increase surface area and flow-through. Similarly, the barriers and/or baffles can be adjusted to such shape such that flow 101B can be channeled in and around such electrodes 110 to increase contact time in the interior 114.

The size and shape of the ozone module 100, and any baffles 405 used therein, may take on a wide variety of shapes. FIG. 5A illustrates a cylindrical example of the ozone module 100, including a set of convolutional baffles 505 that direct the flow of the water 103 (e.g., the flow 101B of FIG. 5A) in a circular, rotational, and/or bend path around the interior 104 of the housing 102, according to one or more embodiments. Therefore, in one or more embodiments, the baffle 405 may be a convolutional baffle 505 directing water (e.g., the water 103) in a spiral or “corkscrew” as the water moves through the interior 104 of the housing 102. In one or more embodiments, the convolutional baffle 405 may surround the electrode 110 such that at least a portion of the water moves circularly around the electrode 110 as the water moves from the intake interface 120 to the output interface 130. FIG. 5B provides yet another example, in which a convolutional baffle 505 that is spiral-like and made of plastic, comprising a central electrode mount 508, is placed into a cylindrical instance of the housing 102. The flow 101B of FIG. 5B (not shown), would be at least partially spiralized as the water 103 moves from the direction of the intake interface 120 to the output interface 130.

In one or more embodiments, including the embodiment of FIG. 3, an optional proton exchange membrane (e.g., the PEM membrane) may permit electron flow between the anode and cathode while limiting gas and/or water exchange between two sides and/or poles of the electrode, which may be useful for certain application where separation of hydrogen may be preferred to limit chemical reactions (and in such case the hydrogen may be separately shunted out of the ozone generation module 110).

FIG. 1, FIG. 3, FIG. 4, FIG. 5A, and FIG. 5B provide examples in which a travel distance of the water from the intake interface 120 to the output interface 130 is greater than or equal to a longest dimension of the exterior 106 of the housing 104, which may enhance contact time and ozonation with the water. FIG. 4, FIG. 5A, and FIG. 5B are examples in which a travel distance of the water from the intake interface 120 to the output interface 130 is expected to be multiples (e.g., twice or more) such distance.

It should be noted that in one or more embodiments the electrode 110 can be replaced with a coronal arc ozone generator. An air intake for the coronal arc zone generator may be to an exterior of the housing 102 and brough into the interior 104 via a venturi or air pump.

Although the present embodiments have been described with reference to specific example embodiments, it will be evident that various modifications and changes may be made to these embodiments without departing from the broader spirit and scope of the various embodiments. For example, the various devices, engines and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., the controller 200, the control server 306). Accordingly, the specification and drawings are to be regarded in an illustrative rather than a restrictive sense.

The structures in the figures such as the engines, routines, and modules may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the preceding disclosure.

1. An ozone generation module for generating ozonating water, the ozone module comprising:
a housing having an interior of the housing and an exterior of the housing,
an intake interface set in the housing for conveying a water into the interior of the housing,
an electrode exposed to the interior the housing, the electrode comprising an anode and a cathode that generates at least one of dissolved ozone and gaseous ozone in the water when a current is applied across the anode and cathode to result in an ozonated water,
power leads comprising a first power lead coupled to the anode and transiting to the exterior of the housing and a second power lead coupled to the cathode and transiting to the exterior of the housing, and
an output interface for outputting the ozonated water from the housing.

2. The ozone generation module of claim 1, further comprising:
a baffle impeding a flow of the water from the intake interface to the output interface to increase contact time of the water with at least one of the electrode and the dissolved ozone.

3. The ozone generation module of claim 2,
wherein the baffle is a convolutional baffle directing water in a spiral as the water moves through the interior of the housing, and
wherein the convolutional baffle surrounding the electrode such that at least a portion of the water moves circularly around the electrode as the water moves from the intake interface to the output interface.

4. The ozone generation module of claim 1, further comprising:
a flow detector configured to detect at least one of a flow of the water and a flow rate of the water moving through the ozone module, and
a sensor line coupled to the flow detector and transiting the housing for communicating a flow signal.

5. The ozone generation module of claim 1, further comprising:
a controller communicatively coupled to the power leads comprising:
a processor,
a memory comprising:
a configuration data comprising at least one of a voltage value and an amperage value, and
an ozone initiation routine comprising computer readable instructions that when executed:
receive an execution command,
determine at least one of the flow is occurring and the flow rate exceeds a threshold value, and
supply power to the power leads according to at least one of the voltage value and the amperage value.

6. The ozone generation module of claim 5, further comprising:
a user interface communicatively coupled to the controller for generating the execution command,
wherein the user interface comprising a light interface, and
wherein the memory further comprising an ozone indication routine comprising computer readable instructions that when executed:
initiate a first color on the light interface indicating that an ozone concentration in the water is insufficient,
determine at least one of the flow has exceeded a threshold time and the flow rate of the water has exceeded a threshold volume specified in the appliance configuration data, and
initiate a second color on the light interface indicating that the ozone concentration in the water is sufficient.

7. The ozone generation module of claim 2, wherein the baffle impeding the flow of the water comprises a first barrier between the anode and the cathode, a second barrier between the anode and the interior of the housing, and a third barrier between the cathode and the interior of the housing.

8. The ozone generation module of claim 7,
wherein at least one of the intake interface and the output interface comprise a quick connect coupler,
wherein the anode of the electrode comprising at least one of boron doped diamond and tin-nickel oxide,
wherein the cathode of the electrode comprising stainless steel,
wherein the anode and cathode electrically coupled with a proton exchange membrane (PEM) such that the water flows around the electrode without passing through a gap between the anode and cathode, and
wherein a travel distance of the water from the intake interface to the output interface is greater than or equal to a longest dimension of the exterior of the housing.

9. The ozone generation module of claim 1, further comprising:
a power supply electrically coupled to the electrode,
a total dissolved solid (TDS) sensor for detecting a TDS value of the water,
wherein the memory further comprising a TDS regulation routine comprising computer readable instructions that when executed:
detect the TDS value of the water,
determine a second voltage value to supply to the electrode at the TDS value, and
supply power to the electrode at the second voltage value and at a current value that is constant,
wherein the power supply includes a constant voltage power supply and optionally a constant current power supply.

10. The ozone generation module of claim 1,
wherein the memory further comprising a module coordination routine comprising computer readable instructions that when executed:
determine an error status of the ozone module, and
initiate ozone generation of a second ozone module serially configured with the ozone module along a flow channel of the water, and
wherein the memory further comprising an electrode monitoring routine comprising computer readable instructions that when executed:
detect an error status resulting from an electrical property of the electrode, and
at least one of activate an indicator element of a user interface and stop power flowing from the power supply to the electrode,
wherein the electrical property is a resistance change in the electrode.
